(19) United States
(12) Patent Application Publication
(10) Pub. No.: US 2026/0100768 A1
(43) Pub. Date: Apr. 9, 2026

(54) SYSTEMS AND METHODS FOR GENERATING ENTROPY ACCORDING TO A DESIRED DISTRIBUTION

(71) Applicant: ANAMETRIC, INC., Austin, TX (US)

(72) Inventors: Mitchell A. Thornton, Dallas, TX (US); William V. Oxford, Austin, TX (US); Duncan L. MacFarlane, Dallas, TX (US)

(21) Appl. No.: 19/346,113

(22) Filed: Sep. 30, 2025

Related U.S. Application Data
(60) Provisional application No. 63/703,516, filed on Oct. 4, 2024.

(51) Int. Cl. H04B 10/70; G02F 1/21; H04B 10/67

(52) U.S. Cl. CPC H04B 10/70; G02F 1/212; H04B 10/671

(57) ABSTRACT

Photonic quantum random number generators (QRNGs) that may natively generate entropy of a desired distribution (e.g., according to a desired PDF) are disclosed. These photonic QRNGs may comprise a photon source coupled to a Mach-Zehnder Modulator (MZM) array comprising a set of MZMs. This array of MZMs can be coupled to a photodetector array comprising a set of photodetectors. An extractor can be coupled to the photodetector array where the extractor is adapted to produce values based on detection of photons at the photodetector array. The MZM array can be tuned to achieve a desired distribution of entropy.

### RELATED APPLICATIONS

This application claims a benefit of priority under 35 U.S.C. § 119 to United States Provisional Patent Application No. 63/703,516 filed October 4, 2024, entitled “Systems and Methods for Generating Entropy, Including Binomially Distributed Entropy”, which is hereby fully incorporated by reference in their entirety.

### TECHNICAL FIELD

This disclosure relates generally to quantum computing. In particular, this disclosure relates to embodiments of systems and methods for quantum generation of random numbers. Even more specifically, this disclosure relates to the generation of entropy (e.g., one or more random numbers) with a desired distribution.

### BACKGROUND

Many computing devices require a continuous supply of random values to support the implementation of various modern cryptographic methods or for other reasons. The lack of such high-quality random number sources in otherwise secure computing systems has been the cause of several well-documented security breaches. Moreover, it is desirable for the generation of these random numbers or bit streams to be accomplished at high data rates to support applications such as modern secure high-speed communications. This need is coupled with the added constraint that random values must be of very high quality in terms of their independence and other statistical properties in order to preserve the integrity of, for example, encryption protocols or other computing operations based on such random numbers. The massive growth in the market share of small, inexpensive devices means that the vast majority of connected devices are now low-cost devices that have traditionally featured relatively poor on-board entropy sources.

This lack of high-quality entropy limits the security attainable with such low-cost devices, subsequently putting all of the devices that are connected with them at risk. Additionally, many of these devices are mobile, meaning that their networked connections, which must be secured, require a larger proportion of authentication and key exchange operations than in the past –which, in turn, consumes more entropy.

Accordingly, there is a need for systems and methods for relatively inexpensive high-speed and high-quality random number generators.

### SUMMARY

As discussed, the quality of the random values produced by small, low-cost devices is important. In general, there are two main methods by which entropy is generated, so-called “True Entropy Generators (TRNGs) and “Deterministic Random Bit Generators” (DRBGs). Because of their higher speed, DRBGs have traditionally supplied the vast majority of the entropy that is used in the world today. But such DRBGs are not secure unless they are “seeded” with True Entropy (from TRNGs). Thus, TRNGs are a necessary component of modern secure communications and computing.

However, TRNGs can be further divided into classical TRNGs and Quantum-based TRNGS (referred to as QRNGs). One of the advantages of QRNGs over classical TRNGs is that the output of a QRNG cannot be predicted, whereas the output of classical TRNGs sometimes can be predicted by analyzing either previous TRNG output data or by side-channel attacks. Accordingly, much effort has been put into creating small, low-cost and high-output QRNGs.

More recently, the need for non-uniform probability distribution functions (PDFs) has become more important. This is due to the increase in use of Post-Quantum Cryptographic (PQC) algorithms, many of which require sampled gaussian or other non-uniform PDFs to operate securely. Thus, there is a need for low-cost QRNGs, which produce better entropy as well as non-uniform PDF entropy to generate the higher-quality entropy required by modern PQC algorithms. One of the lowest-cost methods for building a QRNG is to use photonic techniques. Photonic circuits are also more resistant to side-channel attacks.

To that end, among others, embodiments of a photonic QRNG that may natively generate entropy of a desired distribution (e.g., according to a desired PDF) are disclosed. A photonic QRNG may be constructed in several different forms, but in general, they comprise a photon source coupled to one or more photonic circuits that implement the QRNG architecture. One such embodiment involves an array of Mach-Zehnder Modulator (MZMs) that act upon the photon source input. This array of MZMs can be coupled to a photodetector array comprising a set of photodetectors.

Specifically, in one embodiment, the MZM array may comprise a number of levels (e.g., more than one level) of cascaded MZMs. The inputs an MZM in the first level of the MZM array may be coupled to a photon source. MZMs in each intermediate level of the MZM array have inputs coupled to a MZM in a previous level of the MZM array and outputs coupled to the inputs of an MZM in a subsequent level of the MZM array. The outputs of the MZMs of the last level of cascaded MZMs in the MZM array may be coupled to corresponding photodetectors in the photodetector array adapted to detect (e.g., be triggered by) the presence of a photon at an output of the corresponding MZM.

In one embodiment, the set of MZMs are cascaded, wherein an MZM at a first level of the MZM array is coupled to a first output of the photon source, an input of each MZM in an intermediate level of the MZM array is coupled to an output of an MZM in a previous level, and each MZM in a last level is coupled to the photodetector array

These photodetectors are coupled to an entropy extractor. This entropy extractor can be adapted to extract random values as the output of the QRNG, where those random values may conform to a desired distribution (e.g., be based on a desired distribution of photons at photodetectors in the photodetector array).

The photon source may be adapted to produce a photon pair, the first photon of the photon pair produced on the first output and a second photon of the photon pair produced on a second output of the photon source. A quantum effect such as Four-Wave-Mixing (FWM) or Spontaneous Parametric Down Conversion (SPDC) is typically used to implement this photon pair source, but these are simply two common methods for generating a quantum-effect-sourced photon pair. The quantum nature of such photon pair sources is used to ensure that the two photons in the pair are generated at exactly the same time. Thus, we can use the presence of one of the pair to infer (or “herald”) the presence of the second photon in the photonic circuit without needing to detect the second photon.

The extractor is coupled to the second output of the photon source and it is adapted to identify or qualify a detection of the second photon in the photodetector array based on whether the first photon was detected at exactly the same time as the second photon. This coincidence is used to indicate that the detection of the second photon is a quantum-based event (i.e., a single photon) as opposed to a classical event (i.e., a detection of more than one photon). Thus qualified, the detection of the single second photon can then be expected to exhibit non-classical properties, hence the characterization of such a system as a QNRG, as opposed to a TRNG.

In particular, to achieve a desired distribution, embodiments may include an MZM array controller. The MZM array controller may include logic or programming to control one or more MZMs of the MZM array to achieve the desired distribution of photons or random values that are the output of the QRNG (e.g., uniform, Gaussian, binomial, etc.). Specifically, the MZM array controller may be coupled to the one or more of the MZMs of the MZM array (e.g., in some embodiments all of the MZMs of the MZM array) to provide a control signal to control the phase shifting or beam splitting configuration of one or more of the MZMs to which it is coupled to effect the desired distribution of photons at photodetectors or random output values from the QRNG.

In one embodiment, the MZM array controller may tune the MZM array to obtain the desired output distribution. Such tuning may be accomplished by performing (e.g., continuous or at intervals) sampling of the output of the extractor and to control the one or more MZMs by varying the control inputs until the desired distribution is achieved.

Accordingly, embodiments include a QRNG comprising a photon source adapted to generate a first photon pair and a MZM array comprising a set of MZMs that act upon one of the photons in that pair. The input of the MZM array can be coupled to the photon source to receive the first or the second photon in the pair. A photodetector array comprising a set of photodetectors is coupled to an output of the MZM array and adapted to detect the either of the photons in the first photon pair on the output of the MZM array. Based on detections from the set of photodetectors an extractor coupled to the photodetector array may generate a set of values as output of the QRNG. This set of values may conform to a desired distribution.

In some embodiments, the extractor is a two-dimensional (2D) extractor. Thus, in some cases the desired distribution comprises a first desired distribution in a first dimension and a second desired distribution in a second dimension. These distributions may be independent, for example, the first desired distribution or second desired distribution may each comprise a uniform distribution, a Gaussian distribution, or a binomial distribution.

Embodiments of a QRNG can include a MZM array controller adapted to control the MZM array to achieve the desired distribution of the set of values. The MZM array controller may be adapted to sample the output of the QRNG or the output of the photodetector array to control the MZM array to achieve the desired distribution. Specifically, in certain embodiments, the MZM array controller is adapted to control the phase shifting or beam splitting configuration of one or more of the MZMs of the set of MZMs of the MZM array (e.g., to achieve the desired distribution).

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a plot of an exemplary uniform entropy probability distribution function.

FIG. 2 is a plot of an exemplary non-uniform entropy probability distribution function.

FIG. 3 is a block diagram of a canonical architecture for a random number generator.

FIG. 4 is a block diagram of one embodiment of a quantum random number generator.

FIG. 5 is a die photo of an integrated photonic circuit that implements the quantum random number generator according to an embodiment.

FIG. 6 is a flow diagram depicting one embodiment of a method for operating a quantum random number generator.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions or rearrangements within the spirit or scope of the underlying inventive concept will become apparent to those skilled in the art from this disclosure.

Before describing embodiments in more detail, some context may be useful. In large part, the computer security of the entire world depends on a small set of “difficult to invert” mathematic algorithms. These include the Rivest-Shamir-Adleman (RSA) cryptosystem, Elliptic Curve Cryptography (ECC) and the Diffie-Hellman (DH) algorithms. These three mathematical functions are used as the underpinning for the world’s online computing environment and economy. In addition to privacy, the ability to transact business across the internet depends on the security of these algorithms.

In 1994, Peter Shor published a paper where he outlined a quantum-based algorithm that can immediately compromise the mathematical underpinnings for RSA, ECC and DH based cryptosystems. This is a much more serious problem than a one-time “hack” of a flawed realization of a theoretically correct security system. Shor’s algorithm represents a fundamental break in the mathematics of nearly all currently widely deployed asymmetric cryptography. Even a perfectly executed secure system (if such a thing existed) would thus be at risk of complete and irrecoverable compromise.

The term Post-Quantum Cryptography (PQC) is used to describe a new set of cryptographic systems based on mathematics that are thought to be resistant to Shor’s algorithm. The National Institute of Standards and Technology (NIST) (along with their international collaborators) have been studying these new PQC algorithms for nearly the last decade. In 2024, a final standard for the first round of new PQC algorithms was released. See, e.g., NIST’s Post-Quantum Cryptography Standardization (e.g., FIPS 203, 204, and 205) including algorithms based on Learning-with-Errors and Lattice-based cryptographic systems as well as Stateless Hash-based signatures which are fully incorporated herein in their entirety.

Essentially, the strategy is to replace the basic mathematics underlying almost all of today’s asymmetric crypto systems with one or more of these new PQC algorithms. From a computational perspective, the most efficient of these PQC algorithms are roughly equivalent to currently existing cryptosystems, but several of these new algorithms can be up to ten times more complex than the existing standards. More critically, however, almost all of the new PQC algorithms require a great deal more memory to execute successfully than today’s standards.

In addition, there are other aspects of PQC (specifically, some entropy constraints) that can cause these memory space requirements to inflate even further -in many cases by as much as another order of magnitude. In practice, the new algorithms’ memory requirements can thus be roughly one thousand to ten thousand times larger than that required by the current (non-PQC) standards, depending on the algorithm. While the performance problem can be solved by accepting lower throughput, solving the memory issue is much more difficult to address, especially in smaller (e.g., Internet-of-Things or IoT) devices, where the memory cannot easily be expanded.

Entropy is of paramount importance in secure encryption for modern computing systems. To illustrate, all secure encryption technologies depend on two main components: strong encryption technologies and good entropy. Although it is not generally appreciated how essential this latter component is, it is not terribly surprising. Even the world’s most sophisticated security system will be utterly useless if the user of that system chooses an easily guessed password. The “entropy content” (randomness) of an encryption key (i.e.,password) is paramount in the quest for strong cryptographic protection. In the past, only relatively simple keys have been needed to keep hackers at bay. For example, a simple password like “12345” has been trivial to attack, but some slightly more sophisticated secret keys like:“06bef32407e28aca93bb9473ea22a0b4c0d319509d2fd89516cc7aa4be4995b3”, for example, have been generally secure against all but the most well-funded cryptographic adversaries. This is no longer the case.

The second secret key example above may seem fairly random at first glance. But in fact, it is the same “12345” sequence, but run through the SHA256 Hash function 3 times, the third time with the original “12345” text appended to the result prior to the final SHA256 pass. This multi-stage hash procedure is similar in structure to the accepted “HMAC” standard. So what looks like a very random string is actually not much more secure than the original “12345” and can be easily guessed -if you know the correct procedure for predicting the next set of values, based on what is publicly known. The difference between truly random message strings and the example above may be difficult to distinguish by humans, but the advent of advanced Machine Learning (ML) has changed that convention. ML algorithms are specifically designed to identify structure in seemingly random data and they have already been used for more than a decade to compromise systems around the world that were previously considered secure.

Thus, PQC implementations need high-bandwidth, high-quality sources of entropy. IoT devices add the further constraint that these entropy sources must operate with very low power consumption. The highest-quality entropy generators in existence may be based on quantum events; so-called Quantum Random Number Generators (QRNGs). The lowest-power implementations of these QRNGs are typically photonic (i.e., light-based).

There is also one more property of the entropy required by many PQC algorithms that must be carefully considered. That aspect is known as the probability distribution function (PDF). Essentially, this is the cumulative probability that any one output sample of the random stream falls within certain numerical limits.

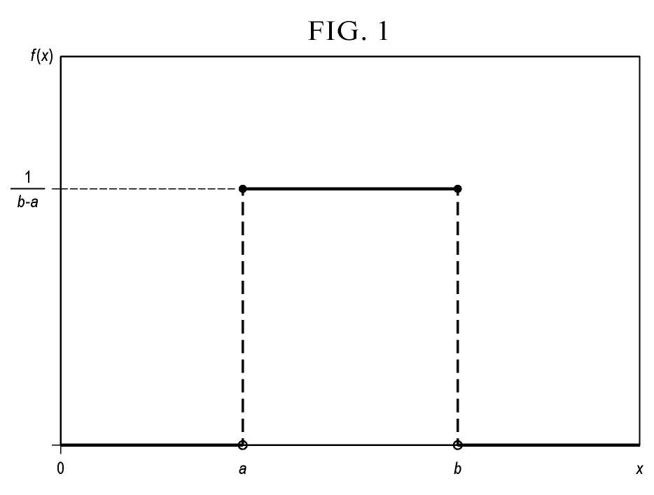

Consider the plot shown in FIG. 1, which is a histogram of the output of an RNG that features a “uniform” PDF. It is clear from the plot in FIG. 1 that the results produced by this RNG are -on average- equally distributed in the range between “a” and “b”. In other words, the likelihood of observing any result within that range is essentially the same. This “uniform” PDF is the simplest kind of distribution to produce and it is the most commonly generated form of entropy in traditional cryptography.

As stated earlier, however, newer PQC algorithms require much more entropy (e.g., to accomplish even a single key exchange or to produce a signature) than classical cryptography. However, the security proofs of most of these new algorithms are also dependent on the entropy distribution being in the form of a sampled gaussian or normal distribution as opposed to a uniform PDF.

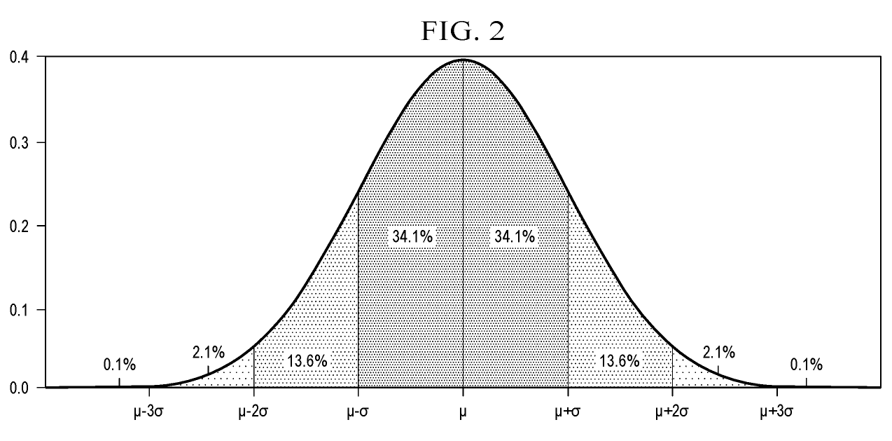

FIG. 2 shows a histogram of an RNG with this kind of PDF. The distribution of values shown in FIG. 2 is observed in many situations. Some examples include descriptions of the behavior of collections of physical systems and in financial transaction data. The underlying theory is based on the fact that that a normal distribution describes the behavior of large collections of independent processes (such as the statistics of the errors observed in sets of uncorrelated measurements).

Other important statistical uses of the normal distribution include Bayesian Estimation and in Large Language Models, where it is essential for building reliable models from real-world data. But most importantly for cryptography, the sampled gaussian distribution is required for the entropy employed in Learning-with-Errors (LWE) and Lattice-based cryptography, which form the basis of several of the current top candidates for PQC algorithms. In addition, the requisite distribution for many of the top candidates of these PQC solutions is multi-variate (i.e., more than single-dimensional). Thus, while the overhead required for PQC over classical cryptography is much larger in even one dimension, it can be multiplicative with the number of dimensions required by certain algorithms.

As was noted, the vast majority of today’s cryptographic entropy is generated with a uniform PDF. There are several different methods by which sampled gaussian PDF entropy can be derived from uniform PDF entropy. However, there is a substantial cost involved, both in computational resources as well as in memory. Some published assessments of the computational overhead required to generate entropy in the proper form suggest that as much as 40% of the compute cycles for a given PQC key exchange are consumed by transforming the entropy required by a PQC algorithm from a uniform PDF to a sampled Gaussian PDF.

In addition to this major computational overhead, the production of a sampled Gaussian PDF requires approximately ten times the amount of Uniform PDF entropy in order to generate data with the proper statistics. Thus, in order to execute a single PQC key exchange using a LWE or Lattice-based algorithm, between approximately one thousand and one hundred thousand times the amount of uniform PDF entropy must be produced than is required for today’s RSA or Diffie-Hellman key exchanges. While this computational overhead may be tolerable for some low-performance, low-end (e.g., IoT) devices, these are exactly the kinds of devices that are memory-constrained. Thus, in many cases, it is simply not possible to upgrade these low-end devices to add PQC capabilities without replacing the hardware.

Thus, what is desired are RNGs that are capable of natively generating non-linear distributions of entropy in an efficient and high-speed manner.

To that end, among others, embodiments of a photonic QRNG that may natively generate entropy of a desired distribution (e.g., according to a desired PDF) are disclosed. This photonic QRNG may comprise a photon source coupled to a Mach-Zehnder Modulator (MZM) array comprising a set of MZMs. This array of MZMs can be coupled to a photodetector array comprising a set of photodetectors

Specifically, in one embodiment, the MZM array may comprise a number of levels (e.g., more than one level) of cascaded MZMs. The inputs an MZM in the first level of the MZM array may be coupled to a photon source. MZMs in each intermediate level of the MZM array have inputs coupled to a MZM in a previous level of the MZM array and outputs coupled to the inputs of an MZM in a subsequent level of the MZM array. The outputs of the MZMs of the last level of cascaded MZMs in the MZM array may be coupled to corresponding photodetectors in the photodetector array adapted to detect (e.g., be triggered by) the presence of a photon at an output of the corresponding MZM.

These photodetectors are coupled to an entropy extractor. This entropy extractor can include an accumulator and may may be, for example, a 2D extractor. This entropy extractor can be adapted to extract random values as the output of the QRNG, where those random values may conform to a desired distribution (e.g., be based on a desired distribution of photons at photodetectors in the photodetector array). For example, in one dimension the extractor can accumulate a number of triggers of each photodetector over a sampling period to generate bits for a random value for output of the QRNG. In another dimension, the extractor may utilize the timing of the triggers of the photodetector as a source of randomness for generating random values as output of the QRNG. The sampling rate utilized may be dependent, for example, on the quench time (e.g., ringdown time) or other characteristics of the photodetectors employed, the output brightness (strength) or other characteristics of the photon pair source, or other criteria. Such a sampling rate can be implemented, for example, using a (e.g., tunable) clock included in entropy extractor.

In particular, embodiments may include an MZM array controller. The MZM array controller (or just MZM controller) may include logic or programming to control one or more MZMs of the MZM array to achieve the desired distribution of random values that are the output of the QRNG (e.g., uniform, Gaussian, binomial, etc.). Specifically, the MZM array controller may be coupled to the one or more of the MZMs of the MZM array (e.g., in some embodiments all of the MZMs of the MZM array) to provide a control signal to control the phase shifting or beam splitting configuration of one or more of the MZMs to which it is coupled (e.g., by adjusting a voltage signal to the one or more MZMs) to effect the desired distribution of random output values from the QRNG.

In one embodiment, the MZM array controller may tune the MZM array to obtain the desired distribution. Such tuning may be accomplished by sampling (e.g., continuous or at intervals) the output of the extractor and using that sampled output to derive the desired control of one or more MZMs by varying the voltage or current input until the desired distribution is achieved. These settings (e.g., the voltages or other control signal input values for each of the one or more MZMs that produce the desired distribution) may be stored such that the desired distribution may subsequently be more quickly achieved using these stored settings. In this manner, multiple distribution settings may be stored by the MZM controller such that these settings may be selected to achieve the desired distribution of random values in the future (e.g., without retuning of the QRNG).

In addition to accomplishing such QRNG tuning using the triggering of photodetectors of the photodetector array based on single photon detection (e.g., with the photodetectors in avalanche mode), such tuning may also be accomplished using brightness indications sensed at each photodetector. Here, the gain may be adjusted or raised at the photon source to produce photons at a rate at which individual photons may not be detectable by the photodetectors of the photodetector array. Alternatively, or additionally, the photodetector may be utilized as a linear or pin detector as opposed to an Avalanche Detector. This modified detection mode may be accomplished by simply adjusting the reverse bias of the photodiode. The advantage of running the diode in linear mode as opposed to avalanche mode is mainly for speed of operation. Thus, in a high-brightness situation, the photonic circuit can be more quickly characterized than when it is operated in quantum (low-brightness) mode. The MZM array controller can then adjust the control signals to each of the one or more MZMs of the MZM array to adjust the (e.g., relative) brightness detected at each photodetector based on the desired distribution. These settings for these control signals (e.g., the voltages or other control signal input values for each of the one or more MZMs that produce the desired distribution) may be stored such that the desired distribution may subsequently be achieved using these settings. However, once the characterization is complete (and thus, the tuning of the control circuit is accomplished), then the photon source may be adjusted to a low-brightness operating mode, where we can then use the MZM array in “quantum mode” for generating the desired QRNG output.

Furthermore, the entropy extractor may be adapted to discern legitimate detection of a photodetector from triggering of a detector of the photodetector array for other causes (e.g., where the photodetector was triggered based on noise or the like). In such embodiments, the photon source may be a photon pair source adapted to produce a photon pair such as an idler and signal photon pair. One photon of the produced pair may be provided to the MZM array while the other photon of the pair may be provided directly (e.g., on a waveguide) from the photon pair source to the extractor. In this manner, if a triggering of a photodetector is detected outside some window of time before or after reception of a photon directly from the photon pair source (or vice versa, or if multiple photons are received from the photon source, etc.) it can be determined that the detected triggering of the photodetector was due to noise (e.g., and that detection event discarded in the determination of a random value for the QRNG by the extractor).

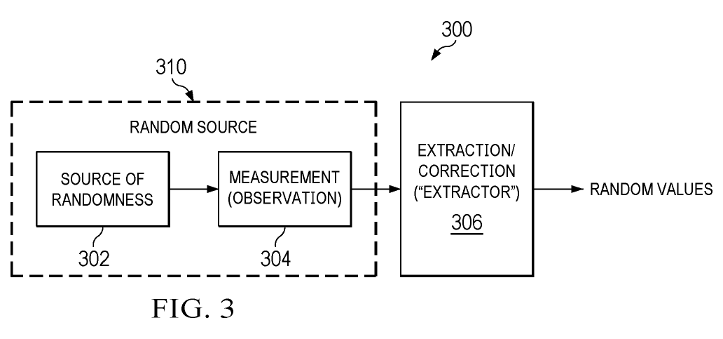

Turning to embodiments, and looking now at FIG. 3, an architecture for a random number generator (RNG) 300 (sometimes referred to as a True RNG or TRNG). TRNG 300 includes a randomness source 310 including physical source of randomness 302 and an observation or measurement stage 304. TRNG may also include a post-measurement processing stage 306 known as an “extractor”. The physical source 302 produces a source of randomness, the measurement stage 304 observes the source of randomness 304 and provides the observations to the extractor function 306 that transforms the measured output of the physical source 302 into random values that can be output and used for a variety of purposes.

The source of randomness 302 in embodiments may be a photon source and an MZM array, while the measurement 304 may include a set of photodetectors. TRNG 300 incorporates extractor logic or functions 306, or simply “extractor,” that transforms the output of a (e.g., weakly) random source 310 into an) an independent string of random bits of a desired distribution that can be output as the random values of the TRNG 300. This distribution can be equally likely (i.e., a uniform probability distribution), a Gaussian distribution, a binomial distribution, etc.

More specifically, the purpose of the extractor 306 may be to discard undesired biases, correlations, or other deterministic components in the source measurements provided by measurement stage 304 and to transform random values to output values that are as close as possible to being independent and that are distributed as desired. Ideally, extractor function 306 produces values that are independent and distributed according to a desired distribution. Thus, according to embodiments the source of randomness 302 (or measurement 304) such as the MZM array may be controlled such that TRNG 300 produces random values of a desired distribution.

As was noted earlier, the vast majority of today’s cryptographic entropy is generated with a uniform PDF. However, in many cases other distributions of entropy (e.g., Gaussian, binomial, etc.) may be desired in a number of contexts. Additionally (much) greater amounts of entropy may be desired than can currently be efficiently generated by today’s RNGs. Accordingly, embodiments of a photonic QRNG as disclosed herein are based on a unique mechanism that is specifically designed to be able to natively generate a desired distribution of entropy (e.g., for sampled gaussian PDF entropy). Thus, embodiments of a QRNG as disclosed may consume far lower power than traditional RNGs and are able to generate desired distributions of random values (e.g., without the computationally expensive and highly memory-intensive conversions such as uniform PDF to sampled Gaussian PDF transformation steps).

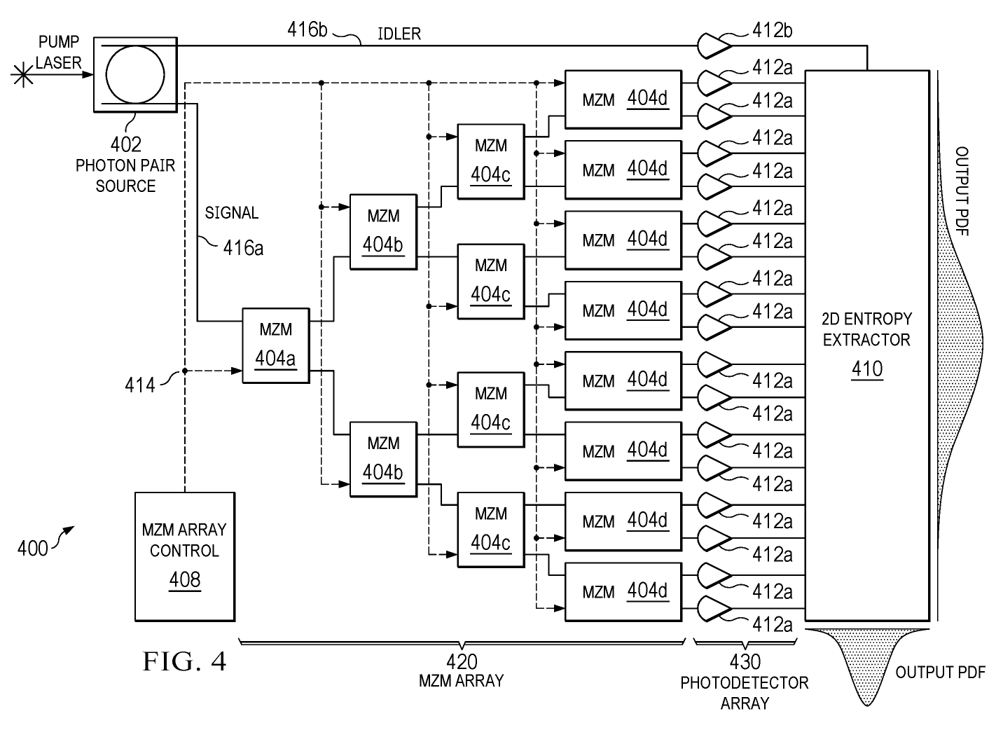

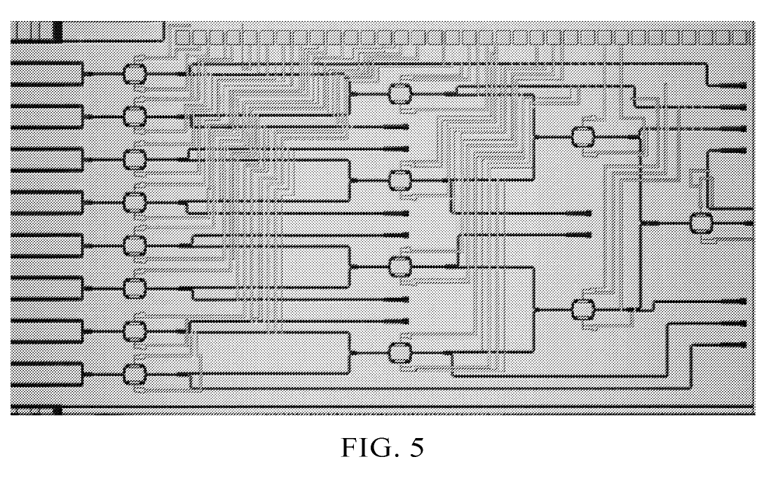

FIG. 4 depicts one embodiment of a QRNG system adapted to generate a desired distribution of (e.g., random) values. A chip die photo showing one embodiment of a silicon photonic implementation of one embodiment of a QRNG is shown in FIG. 5. Referring to FIG. 4, such a QRNG 400 can, for example, generate values for a sampled gaussian PDF or other desired distribution (e.g., simultaneously in two dimensions). Specifically, QRNG 400 may comprise a photon source 402 coupled to MZM array 420 array comprising a set of MZMs 404. This array 420 of MZMs 404 can be coupled to a photodetector array 430 comprising a set of photodetectors 412a. In one embodiment, photon source 402 can comprise a pulsed laser source serving as a photon pump and a half-wave plate (HWP) for adjusting the angle of linear polarization of a pump photon with the optical axis of a spontaneous parametric down converter (SPDC). Additionally, or alternatively, photon source 402 may also utilize Four-Wave Mixing (FWM). The photon source 402 may thus produce a photon pair (referred to interchangeably as signal photon and an idler photon).

In one embodiment, the MZM array 420 may comprise a number of levels (e.g., more than one level) of cascaded MZMs 404. The inputs of MZM 404a in the first level of the MZM array 420 may be coupled to photon source 402. MZMs 404b, 404c in each intermediate level of the MZM array 420 have inputs coupled to a MZM 404 in a previous level of the MZM array 420 and outputs coupled to the inputs of an MZM 420 in a subsequent level of the MZM array 420. Specifically, each output of each MZM 404 in a previous level may be coupled to a distinct MZM 404 in a subsequent level of the MZM array 420. The outputs of the MZMs 404d of the last level of cascaded MZMs 404 in the MZM array 420 may be coupled to corresponding photodetectors 412a in the photodetector array 420 adapted to detect the presence of a photon at an output of the corresponding MZM 404.

Accordingly, embodiments may include a number of levels of cascaded MZMs) 404, wherein the initial or first level includes a single MZM circuit element 404a with one of its inputs coupled to a first output (e.g., waveguide) 416a of a photon pair source 402 and each of the first-level MZM element’s two outputs are then coupled to an input of an MZM 404b of a subsequent (e.g. second) level of the MZM array 420. Each subsequent level of the QRNG may thus comprise a set of MZM elements 404, each input of an MZM 404 of given level coupled to a corresponding output of an (ancestor) MZM element 404 in the preceding level of the QRNG (e.g., outputs of MZMs 404b in the second level of array 420 are coupled to inputs of MZMs 404c in the third level of array 420). The outputs of the MZMs 404d of the last level of cascaded MZM of MZM array 420 may be coupled to a corresponding photodetector 412a of photodetector array 430, and the outputs (e.g., signal) of each photodetector 412a may be coupled to an entropy extractor 410. While the embodiment of the QRNG 400 depicted in FIG. 4 comprises four levels, it will be noted that other embodiments as contemplated herein may comprise more (or fewer) levels.

This entropy extractor 410 can include an accumulator and may be, for example, a two-dimensional (2D) extractor. This entropy extractor 410 can be adapted to extract random values as the output of the QRNG 400, where those random values may conform to a desired distribution (e.g., a desired distribution in each dimension). For example, in one dimension the extractor 410 can accumulate a number of detections (triggers) of each photodetector 412a over a sampling period to generate bits for a random value for output of the QRNG 400. In another dimension, the extractor 410 may utilize the timing of the triggers of the photodetector 412a as a source of randomness for generating random values as output of the QRNG 400. The sampling rate utilized may be dependent, for example, on the quench time (e.g., ringdown time) or other characteristics of the photodetectors 412a employed, the output strength or other characteristics of the photon pair source 402, or other criteria. Such a sampling rate can be implemented, for example, using a (e.g., tunable) clock included in entropy extractor 410.

In particular, embodiments may include MZM array controller 408 where this MZM array controller may be coupled to each of the MZMs 404 of the MZM array 420 via a control line 414 such that the MZM array controller 408 may be adapted to individually control each MZM 404 by providing an individual control signal to that MZM 404. Specifically, the MZM array controller 420 may be adapted to provide a control signal on control line 414 to control the phase shifting or beam splitting configuration of one or more of the MZMs 404 to which it is coupled (e.g., by adjusting a voltage signal to the one or more MZMs 404).

The MZM array controller 408 may thus include logic or programming to control one or more of the MZMs 404 of the MZM array 420 to achieve a desired distribution of random values that are the output of the QRNG 400 (e.g., uniform, Gaussian, binomial, etc.). In one embodiment, the MZM array controller 420 may tune the MZM array 420 to achieve the desired distribution (e.g., in one or more dimensions). For example, MZM controller 408 may be adapted to perform sampling (e.g., continuous or at intervals, etc.) of the output of the extractor and to control one or more MZMs 404 by varying the control signal on control line 414 to those MZMs 404 until the desired distribution is achieved. For example, such control signals may include signals to (e.g., on-chip) heaters that can change the length or other parameters of a particular waveguide element (e.g., of an MZM 404) and thus, by altering the length or other parameters of a particular waveguide element the phase of photons that exit that waveguide may be altered. This control signal may also include using variations in control voltages to modify the refractive index of a particular waveguide using an electro-optic effect. Other forms of adjustment may also be performed to achieve the desired tuning (e.g., distribution) and all such mechanisms are contemplated herein without loss of generality.

These settings (e.g., the voltages or other control signal input values to provide on control line 414 for each of the one or more MZMs 404 that produce the desired distribution) may be stored such that the desired distribution may subsequently be achieved using these settings. In this manner, multiple distribution settings may be stored by the MZM array controller 408 such that these settings may be selected to achieve the desired distribution of random values in the future (e.g., without retuning of the QRNG 400).

In addition to accomplishing such QRNG tuning using the triggering of photodetectors 412a of the photodetector array 430 based on single photon detection (e.g., with the photodetectors 412a in avalanche mode), such tuning may also be accomplished using brightness indications sensed at one or more of photodetector2 412a. Here, the gain may be adjusted or raised at the photon source 402 to produce photons at a rate at which individual photons may not be detectable by the photodetectors 412a of the photodetector array 430. Alternatively, or additionally, photodetectors 412a may be utilized as a linear or pin detector to detect a brightness signal at one or more photodetectors 412a of the photodetector array 430. The MZM array controller 408 can then adjust the control signals (on control lines 414) to each of the one or more MZMs 404 of the MZM array 420 to adjust the (e.g., relative) brightness detected at each photodetector 412a based on the desired distribution. These settings for these control signals (e.g., the voltages or other control signal input values for each of the one or more MZMs 404 that produce the desired distribution) may be stored such that the desired distribution may subsequently be achieved using these settings.

Furthermore, the entropy extractor 410 may be adapted to discern legitimate detection of a photodetector from triggering of a detector of the photodetector array for other causes (e.g., where the photodetector was triggered based on noise or the like). In such embodiments, the second output (e.g., waveguide) 416b of photon pair source 402 may be coupled to photodetector 412b and the output of photodetector 412b coupled to entropy extractor 410.

In this manner, one photon of the pair of photons produced by photon pair source 402 may be provided to the MZM array 420 (e.g., through waveguide 416a coupled to MZM 404a) while the other photon of the produce photon pair may be provided (e.g., on waveguide 416b) from the photon pair source 402 to the photodetector 412b adapted to provide a detection signal to extractor 410. In this manner, if a triggering of a photodetector 412a in photodetector array 420 is detected outside some window of time before or after detection of a (e.g. corresponding) photon by photodetector 412b (or vice versa, or if multiple photons are detected from the photon source 402, etc.) extractor 410 can determine that the detected triggering of the photodetector 412a was due to noise (e.g., and that detection event discarded in the determination of a random value for the QRNG 400 by the extractor 410).

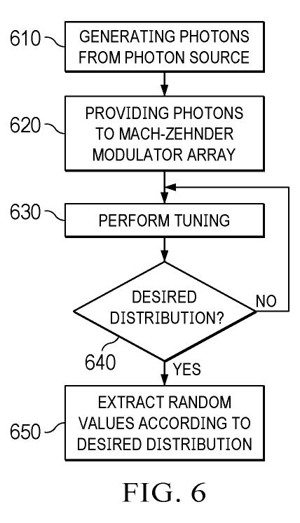

One embodiment of method for operating embodiments of a QRNG as disclosed herein is depicted in FIG. 6. Here, photons generated from a photon source (STEP 610) may be provided to an MZM array (STEP 620). Such an MZM array may include a set of cascaded MZMs coupled to a photodetector array as discussed herein. An extractor of the QRNG is adapted to extract values based on photons detected by the photodetector array. The MZM array can be tuned (STEP 630) until a desired distribution (e.g., of photons detected at photodetectors of the photodetector) is obtained (Y Branch of STEP 640).

Such tuning may be accomplished by performing (e.g., continuous or at intervals) sampling of the output of an extractor of the QRNG or photodetectors of the photodetector array and controlling one or more MZMs of the MZM array until the desired distribution is achieved. This control may include controlling voltages or other control signal input values for each of the one or more MZMs until the desired distribution is achieved for one or more sampling periods.

In the second dimension, this kind of tuning may be accomplished by grouping the measured timing intervals together into quantiles, where the width of a quantile may be adjusted in order to achieve the desired distribution across the various quantile groups. The number of events in each quantile group may be measured to produce a histogram. In this manner, the histogram of the various quantile groups can be used as a completely independent (but nonetheless, still quantum-based) programmable PDF output.

Such QRNG tuning may also be accomplished based on the triggering of photodetectors of a photodetector array based on single photon detection (e.g., with the photodetectors in avalanche mode), or may be accomplished using brightness indications sensed at each photodetector. For example, the photodetector may be utilized as a linear or pin detector to detect a brightness signal at each photodetector of the photodetector array. The MZM array can then be controlled by adjusting the control signals to each of the one or more MZMs of the MZM array to adjust the (e.g., relative) brightness detected at each photodetector based on the desired distribution. Once the desired distribution is achieved (Y Branch of STEP 640), random value can be generated using the tuned QRNG (STEP 650).

Effectively, then, embodiments of a QRNG system may be thought of conceptually along the lines of a photonic implementation of a Galton Board. This structure may also be referred to herein as the “Pachinko” mechanism, due to its similarities in operation to cascading nature of the popular Japanese arcade game. Another reason for calling it a “Pachinko” mechanism is that the probability distribution function of the QRNG system can be adjusted (e.g., in real time) by the MZM array controller (similar in concept to the controls available to Pachinko game players).

It is clear that by being able to natively provide a desired distribution of random values (e.g., according to a sampled gaussian PDF) embodiments offer a unique advantage over other QRNGs (and even other types of TRNG) devices. For example, these embodiments may have the additional facility of being able to have their output probability distribution function “tuned” in real time simply by adjusting the relative phase delays (or other aspects) of the various waveguides that feed the MZM array (e.g.,, the MZM elements) at each level, adjust other aspects of MZMs of the MZM array, or perform various adjustment within or across each level of the MZM array of the QRNG.

This flexibility makes embodiments even more useful for (and much more efficient than) existing mathematical “filter-based” algorithms used to generate the multiplicity of “skewed gaussian” or other distributions such as those required for the correct operation of the Falcon PQC algorithm (which is one of a set of alternate PQC algorithms being considered by NIST for future standardization). The requirement that, in Falcon, these distributions must be dynamically adjustable means that almost all other Falcon implementations are implemented in software (with the associated large memory requirements) and with highly accurate output requirements (e.g., requiring Floating-Point based implementations).

In considering the PDF in particular dimensions (e.g., a first (vertical) or second (horizontal) dimension illustrated in FIG. 4), it will be recalled that the timing of the photonic emission from the photon pair source may, itself, be a source of random events. for example, of either FWM or SPDC. In either case, all of the pair emission events of the photon pair source may be completely independent of each other. Recalling that a statistical normal distribution results from collections of independent random events, then if the pair emission detection timing intervals are measured, then a normal distribution may be observed (e.g., more correctly, a binomial distribution, since the pair emissions are discrete events). Thus, it is possible to combine two measurement vectors: the spatial distribution (e.g., in the vertical direction) of detection events at the photodetectors of the photodetector array and the temporal distribution (e.g., in the horizontal direction) of detection events of photodetectors of the photodetector array in order to generate a 2-dimensional sampled gaussian (or 2D binomial) distribution.

If the measured distribution varies from a “perfect” binomial (or any other distribution it is desired to measure) in either dimension, then the output can be adjusted (e.g., in real time) by further controls. In the spatial dimension, the outputs of all of the photodetectors of the photodetector array can be measured in a high-brightness (i.e., classical) mode in high resolution and then use the MZM array controls to adjust the distribution in order to approximate a true normal (or other) distribution. If the same MZM array controls are maintained as were calculated in the high-brightness (high-precision) case but then reduce the source brightness down to the point where individual photon pairs generated by the photon pair source can be measure, a binomial distribution can be measured with the same high accuracy. Effectively, the depth of the MZM array and the accuracy of the MZM control may be the only limit the accuracy of the binomial distribution.

If the measurements of the temporal distribution do not accurately reflect a binomial distribution, then a post-detection extractor may be utilized in order to “adjust” the inter-event detection events by warping the mapping from the actual measured detection events to an “equalized” true binomial distribution.

Embodiments may thus have a number of important applications. For example, embodiments may be useful in several applications other than PQC (for example, Bayesian modeling and for implementing machine learning inference engines). While not specifically elaborated on, it will be noted that such applications are a matter of using the very same output values for embodiments in a different application and all such applications are fully contemplated herein. Given the large advantage that this approach described above has over traditional sampled Gaussian distribution generation methods, these capabilities may be adapted to accommodate these capabilities using effectively similar embodiments (e.g., for these and future applications that make use of non-uniform entropy distributions). For example, even in cases where silicon has been deployed new applications may be accommodated by way of a software update.

In PQC applications alone, it is estimated that this circuit will offer a ~35-40% lower energy consumption over more traditional implementations. In the machine learning (ML)domain, this functionality can be utilized to enable Internet of Things (IoT)-node model generation at a greatly reduced power consumption. The importance of this kind of “leaf-node” capability is critical, as 90% of the power consumed for most IoT devices is due to the communications bandwidth required for large data sets. Thus, adding edge-level ML preprocessing for the raw data can dramatically reduce overall system power consumption.

Embodiments have been described with reference to specific embodiments. However, one of ordinary skill in the art appreciates that various modifications and changes can be made without departing from the scope of the invention. Accordingly, this description is to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such an embodiment, feature, or function). Rather, the description is intended to describe illustrative embodiments, features, and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Reference throughout this specification to “one embodiment,” “an embodiment,” or “a specific embodiment,” “a specific implementation,” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

Embodiments have been described with reference to specific embodiments. However, one of ordinary skill in the art appreciates that various modifications and changes can be made without departing from the scope of the invention. Accordingly, this description is to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such an embodiment, feature, or function). Rather, the description is intended to describe illustrative embodiments, features, and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Reference throughout this specification to “one embodiment,” “an embodiment,” or “a specific embodiment,” “a specific implementation,” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Furthermore, the term "or" as used herein is generally intended to mean "and/or" unless otherwise indicated. As used herein, a term preceded by "a" or "an" (and "the" when antecedent basis is "a" or "an") includes both singular and plural of such term (i.e., that the reference "a" or "an" clearly indicates only the singular or only the plural). Also, as used in the description herein, the meaning of "in" includes "in" and "on" unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system for a quantum random number generator (QRNG), comprising:
a photon source adapted to generate a first photon;
a Mach-Zehnder Modulator (MZM) array comprising a set of MZMs, an input of the MZM array coupled to the photon source to receive the first photon;
a photodetector array comprising a set of photodetectors, the photodetector array coupled to an output of the MZM array and adapted to detect the first photon on the output of the MZM array;
an extractor coupled to the photodetector array, the extractor adapted to generate a set of values as output of the QRNG based on detections from the set of photodetectors.

2. The system of claim 1, wherein the set of values conform to a desired distribution.

3. The system of claim 2, wherein the extractor is a two dimensional (2D) extractor.

4. The system of claim 3, wherein the desired distribution comprises a first desired distribution in a first dimension and a second desired distribution in a second dimension.

5. The system of claim 4, wherein the first desired distribution or second desired distribution comprises a uniform distribution, a Gaussian distribution, or a binomial distribution.

6. The system of claim 2, further comprising a MZM array controller adapted to control the MZM array to achieve the desired distribution of the set of values.

7. The system of claim 6, wherein the MZM array controller is adapted to sample output of the QRNG or output of the photodetector array to control the MZM array to achieve the desired distribution.

8. The system of claim 7, wherein the MZM array controller is adapted to control the phase shifting or beam splitting configuration of one or more of the MZMs of the set of MZMs of the MZM array.

9. The system of claim 2, wherein the set of MZMs are cascaded, and wherein an MZM at a first level of the MZM array is coupled to a first output of the photon source, an input of each MZM in an intermediate level of the MZM array is coupled to an output of an MZM in a previous level, and each MZM in a last level is coupled to the photodetector array.

10. The system of claim 9, wherein photon source is adapted to produce a photon pair, the first photon of the photon pair produced on the first output and a second photon of the photon pair produced on a second output of the photon source, and wherein the extractor is coupled to the second output and is adapted to discard a detection of the photodetector array based on whether the second photon was received on the second output.

11. A method for quantum random number generation, comparison:
generating photons from a photon source;
providing photons from the photon source to a Mach-Zehnder Modulator (MZM) array comprising a set of MZMs;
detecting photons at a photodetector array coupled to the MZM array; and
generating, at an extractor coupled to the photodetector array, a set of values based on detections from the set of photodetectors.

12. The method of claim 11, wherein the set of values conform to a desired distribution.

13. The method of claim 12, wherein the extractor is a two dimensional (2D) extractor.

14. The method of claim 13, wherein the desired distribution comprises a first desired distribution in a first dimension and a second desired distribution in a second dimension.

15. The method of claim 14, wherein the first desired distribution or second desired distribution comprises a uniform distribution, a Gaussian distribution, or a binomial distribution.

16. The method of claim 15, wherein controlling the MZM array comprises controlling the phase shifting or beam splitting configuration of one or more of the MZMs of the set of MZMs of the MZM array.

17. The method of claim 12, wherein the set of MZMs are cascaded, and wherein an MZM at a first level of the MZM array is coupled to a first output of the photon source, an input of each MZM in an intermediate level of the MZM array is coupled to an output of an MZM in a previous level, and each MZM in a last level is coupled to the photodetector array.

18. The method of claim 17, further comprising discarding, at the extractor, a detection of the photodetector array based on whether a photon of a photon pair was received from the photon source in association with the detection.
